(19) United States
(12) Patent Application Publication
(10) Pub. No.: US 2003/0024364 A1
(43) Pub. Date: Feb. 6, 2003

(54) Circular saw having a tiltable base

(76) Inventor: Lee-Cheng Chang, Taichung (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 09/921,338

(22) Filed: Aug. 2, 2001

(51) Int. Cl. B26D 1/14

(52) U.S. Cl. 83/471.2; 83/477.2; 83/477

(57) ABSTRACT

A circular saw comprises a base and a supporting member for supporting the base above ground, the base being pivotally attached to the supporting member. The base comprises a clamping device mounted thereon for supporting an end of a workpiece. The base is pivotable to a position in which another end of the workpiece is supported by the ground.

### BACKGROUND OF THE INVENTION

1. Field of the Invention

The present invention relates to a circular saw having a tiltable base for preventing hanging of a workpiece to be cut.

2. Description of the Related Art

A typical circular saw comprises a base, a clamping device mounted on the base for clamping a workpiece to be cut, a blade holder pivotally mounted to the holder, and a blade rotatably held by the blade holder for cutting the workpiece. However, when the workpiece is relatively long, a so-called seesaw effect is incurred, as the workpiece is supported at only one end thereof while the other end of the workpiece is hanging outside the base and bends under the action of gravity. Thus, the end of the workpiece on the base must be clamped with a relatively large force so as to avoid vibrations during cutting that would result in an undesired skew cutting face. The present invention is intended to provide an improved circular saw to solve the supporting problem for the workpiece.

### SUMMARY OF THE INVENTION

An object of the present invention to provide an improved circular saw having a base that can be adjusted to an appropriate tilt position to allow the end of the workpiece outside the base to be supported by the ground.

A circular saw in accordance with the present invention comprises a base and a supporting member for supporting the base above ground, the base being pivotally attached to the supporting member. The base comprises a clamping device mounted thereon for supporting an end of a workpiece. The base is pivotable to a position in which another end of the workpiece is supported by the ground.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a circular saw in accordance with the present invention.

FIG. 2 is a perspective view, partly exploded, of the circular saw in accordance with the present invention.

FIG. 3 is a partial sectional view of a portion of the circular saw in accordance with the present invention.

FIG. 4 is a partial side view of the circular saw in accordance with the present invention.

FIG. 5 is a view similar to FIG. 3, illustrating adjustment of the tilt angle of a base of the circular saw in accordance with the present invention.

FIG. 6 is a schematic side view illustrating supporting of a workpiece after adjustment in the tilt angle of the base.

### DETAILED DESCRIPTION OF THE PREFERRED EMBODIMENT

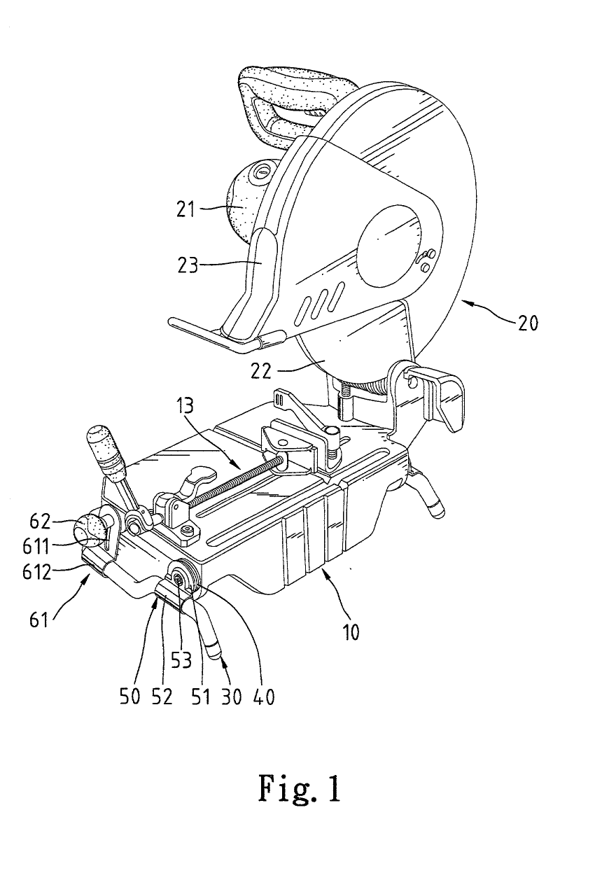

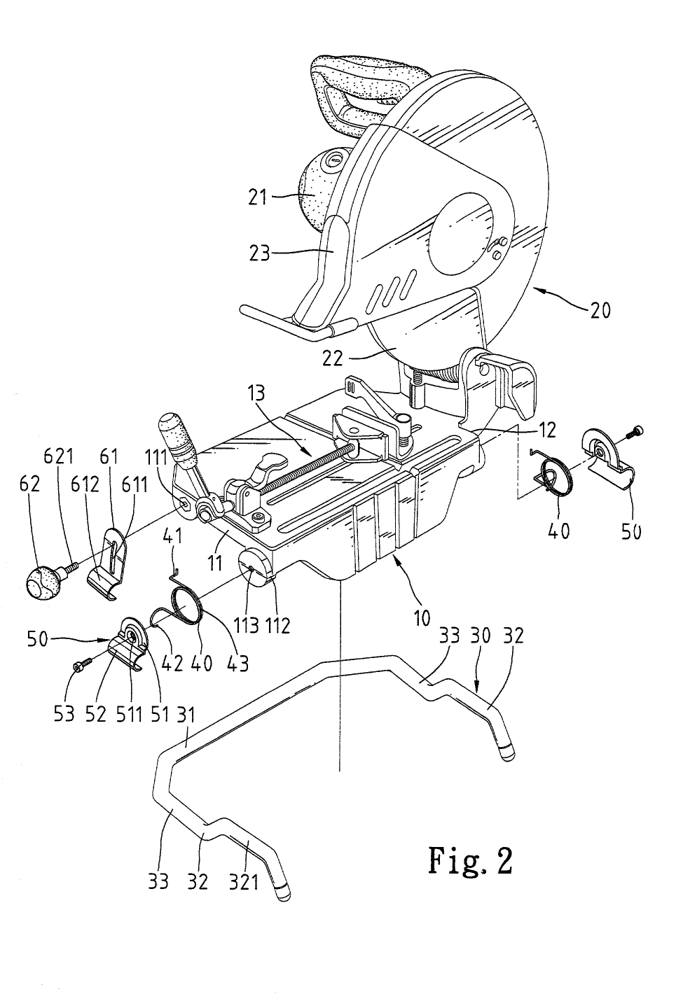

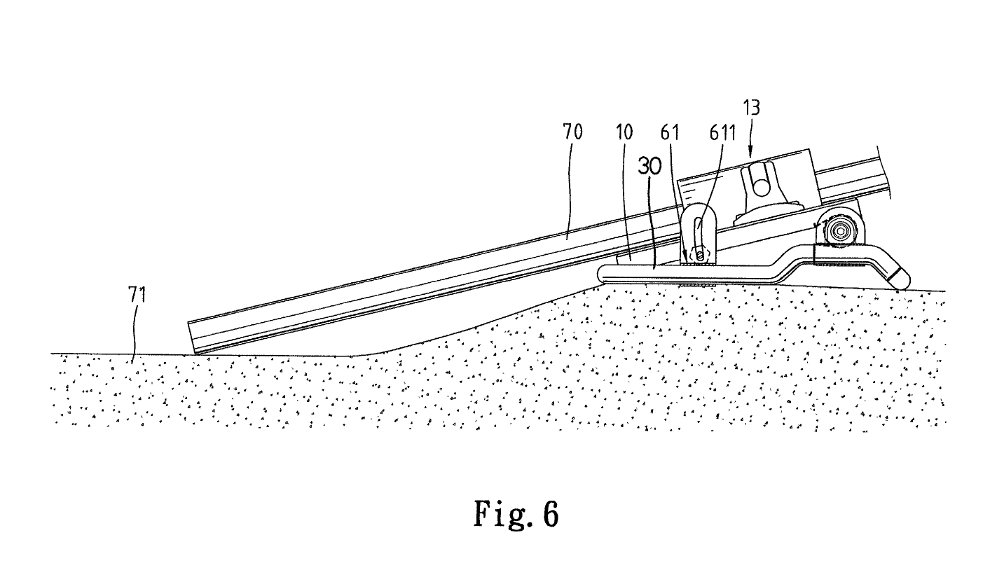

Referring to FIGS. 1 and 2, a circular saw in accordance with the present invention generally comprises a base 10 having a first side 11 and a second side 12 opposite to the first side 11, a clamping device 13 mounted on the base 10 and between the first side 11 and the second side 12 of the base 10, a blade holder 20 pivotally mounted to the second side 12 of the base 10, and a blade 22 rotatably held by the blade holder 20 for cutting a workpiece 70 (FIG. 6) clamped by the clamping device 13. Each of the first side 11 and the second side 12 of the base 1 comprises a screw hole 111 in an end thereof and a circular mounting portion 112 on the other end thereof, the mounting portion 112 having a screw hole 113. A motor 21 is mounted to a side of the blade holder 20 for rotating the blade 22. The blade holder 20 further includes a blade guard 22 for protecting the operator.

A substantially U-shaped supporting member 30 is located on the ground for supporting the base 10 at a level above the ground. The supporting member 30 comprises two limbs 32 connected by an intermediate section 31. Each limb 32 extends zigzag and has a first section 321 located above the ground and a second section 33 located on the ground. The supporting member 30 surrounds the first side 11, the second side 12, and a third side between the first side 11 and the second side 12 of the base 10.

Two elastic elements 40 are respectively mounted to the first side 11 and the second side 12 of the base 10. Each elastic element 40 comprises a coil portion 43 mounted around an associated one of the mounting portions 112. A first end 41 of each elastic element 40 is attached to a bottom of the base 10, and a second end 42 of each elastic element 40 is attached to the first section 321 of an associated limb 32 of the supporting member 30.

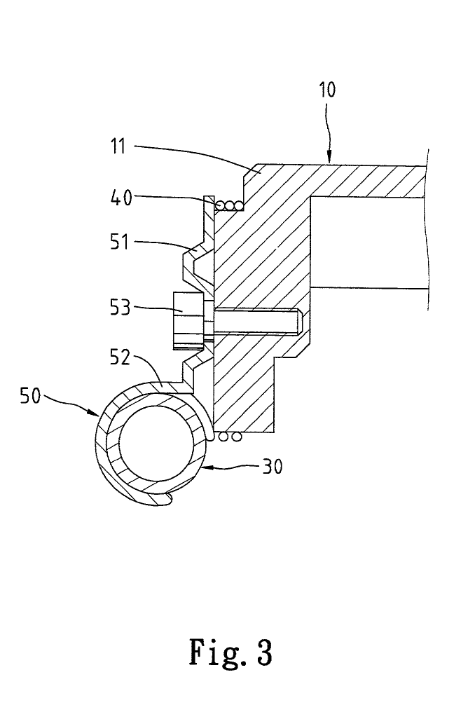

Two fixing members 50 are respectively mounted to the first side 11 and the second side 12 of the base 10. Each fixing member 50 comprises a first end 51 having a hole 511 and a second end 52 in the form of an arcuate hook. A bolt 53 is extended through the hole 511 of the first end 51 of each fixing member 50 and then engaged in the screw hole 113 of the associated mounting portion 112 of the base 11. As illustrated in FIG. 3, each limb 32 of the supporting member 30 is held by the arcuate second end 52 of the associated fixing member 50 to move therewith. Thus, the base 10 may pivot relative to the supporting member 30.

An adjusting device 60 is provided for adjusting the tilt angle of the base 10 relative to the supporting member 30. The adjusting device 60 comprises two guide plates 61 and two locking members 62. Each guide plate 61 includes a first portion having a slot 611 and a second portion 612 in the form of an arcuate hook for holding the second section 33 of the associated limb 32. Each locking member 62 comprises a threaded stem 621 projecting therefrom and extending through the slot 611 of the associated guide plate 61 and then into the screw hole 111 of the associated side 11, 12 of the base 10.

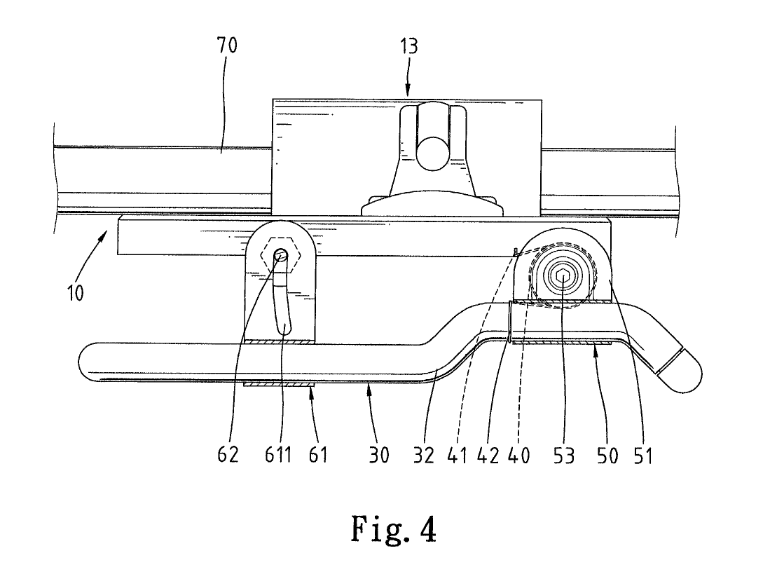

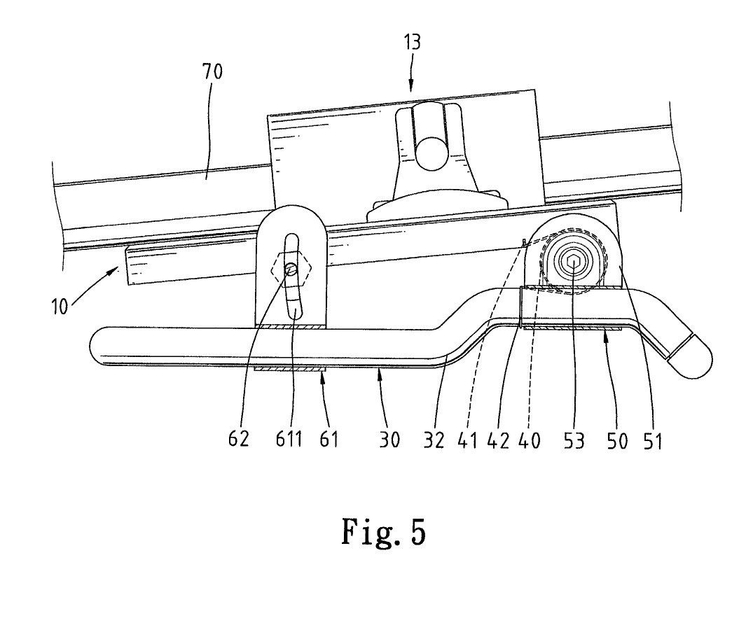

As illustrated in FIG. 4, when the threaded stem 621 of each locking member 62 is located in the upper end of the slot 611 of the associated guide plate 61, the whole base 10 is supported by the supporting member 30 at a level above the ground. When a long workpiece 70 (FIG. 6) is to be cut, an upper end of the workpiece 70 is clamped by the clamping device 13 on the base 10 while a lower end of the workpiece 70 is initially hanging above the ground. Referring to FIG. 5, for solving the supporting problem for the long workpiece 70, the operator may loosen both locking members 62 to allow pivotal movement of the base 10 relative to the supporting member 30. As illustrated in FIG. 5, the slots 611 of the guide plates 61 guide movement of the locking members 62 on the base 10 until the base 10 reaches the desired tilt angle in which the lower end of the workpiece 70 touches and is thus supported by the ground, best shown in FIG. 6. The locking members 62 are then turned in the opposite direction to press against the guide plates 61. Thus, the locking members 62 are retained in place to thereby retain the base 10 in the desired tilt angle. The elastic elements 40 return the base 10 to a substantially horizontal position parallel to the ground after the locking members 62 are loosened. The slots 611 are preferably arcuate for smooth pivotal movement of the base 10.

According to the above description, it is appreciated that the base of the circular saw in accordance with the present invention can be adjusted to an appropriate tilt angle such that the lower end of the workpiece can be lowered to and thus supported by the ground. It is, thus, not necessary to provide a relatively high clamping force for clamping the upper end of the workpiece. The workpiece shall not vibrate during cutting. The structure for adjusting the tilt angle of the base is simple and easy to be mounted onto the base.

Although the invention has been explained in relation to its preferred embodiment, it is to be understood that many other possible modifications and variations can be made without departing from the scope of the invention as hereinafter claimed.

What is claimed is:

1. A circular saw comprising:
a base; and
a supporting member for supporting the base above ground, the base being pivotally attached to the supporting member.

2. The circular saw as claimed in claim 1, wherein the base comprises a clamping device mounted thereon for supporting an end of a workpiece, the base being pivotable to a position in which another end of the workpiece is supported by the ground.

3. The circular saw as claimed in claim 2, wherein the base comprising a first side, a second side opposite to the first side, and a third side between the first side and the second side, the supporting member being a substantially U-shaped member having two limbs and an intermediate section, each said limb comprising a first section located above the ground and a second section located on the ground, the second section being connected with the intermediate section, the supporting member surrounding the first side, the second side, and the third side of the base.

4. The circular saw as claimed in claim 3, further comprising a fixing member for each said limb, each said fixing member comprising a first end pivotally connected to an associated one of the first side and the second side of the base, each said fixing member further comprising a second end for holding the first section of an associated one of the limbs.

5. The circular saw as claimed in claim 4, wherein each of the first side and the second side of the base comprises a circular mounting portion on an end thereof, each said circular mounting portion having a screw hole, the first end of each said fixing member having a hole, further comprising a bolt extending through the hole of each said fixing member and the screw hole of an associated one of the circular mounting portions.

6. The circular saw as claimed in claim 5, further comprising an elastic element mounted to each said circular mounting portion, each said elastic element comprising a coil portion around the associated circular mounting portion, a first end attached to the base, and a second end attached to the associated limb.

7. The circular saw as claimed in claim 5, wherein each of the first side and the second side of the base comprises a second screw hole in another end thereof, further comprising two guide plates respectively mounted to the first side and the second side of the base, each said guide plate comprising a first portion having a slot and a second portion for holding the second section of the associated limb, further comprising two locking members respectively mounted to the first side and the second side of the base, each said locking member comprising a threaded stem extending therefrom, each said threaded stem being extended through the slot of an associated one of the guide plates into the screw hole in an associated one of the second screw holes of the base, each said locking member being slidable in the slot of the associated guide plate when the locking member does not press against the associated guide plate, thereby allowing pivotal movement of the base relative to the supporting member, each said locking member being locked in place when the locking member presses against the associated guide plate, thereby locking the base in place relative to the supporting member.

8. The circular saw as claimed in claim 6, wherein each of the first side and the second side of the base comprises a second screw hole in another end thereof, further comprising two guide plates respectively mounted to the first side and the second side of the base, each said guide plate comprising a first portion having a slot and a second portion for holding the second section of the associated limb, further comprising two locking members respectively mounted to the first side and the second side of the base, each said locking member comprising a threaded stem extending therefrom, each said threaded stem being extended through the slot of an associated one of the guide plates into the screw hole in an associated one of the second screw holes of the base, each said locking member being slidable in the slot of the associated guide plate when the locking member does not press against the associated guide plate, thereby allowing pivotal movement of the base relative to the supporting member, each said locking member being locked in place when the locking member presses against the associated guide plate, thereby locking the base in place relative to the supporting member.

9. The circular saw as claimed in claim 4, wherein the second end of each said fixing member is an arcuate hook for holding the first section of the associated limb.

10. The circular saw as claimed in claim 5, wherein the second end of each said fixing member is an arcuate hook for holding the first section of the associated limb.

11. The circular saw as claimed in claim 6, wherein the second end of each said fixing member is an arcuate hook for holding the first section of the associated limb.

12. The circular saw as claimed in claim 7, wherein the second end of each said fixing member is an arcuate hook for holding the first section of the associated limb.

13. The circular saw as claimed in claim 8, wherein the second end of each said fixing member is an arcuate hook for holding the first section of the associated limb.

14. The circular saw as claimed in claim 7, wherein the second portion of each said guide plate is an arcuate hook for holding the second section of the associated limb.

15. The circular saw as claimed in claim 8, wherein the second portion of each said guide plate is an arcuate hook for holding the second section of the associated limb.

16. The circular saw as claimed in claim 9, wherein the second portion of each said guide plate is an arcuate hook for holding the second section of the associated limb.

17. The circular saw as claimed in claim 10, wherein the second portion of each said guide plate is an arcuate hook for holding the second section of the associated limb.

18. The circular saw as claimed in claim 11, wherein the second portion of each said guide plate is an arcuate hook for holding the second section of the associated limb.

19. The circular saw as claimed in claim 12, wherein the second portion of each said guide plate is an arcuate hook for holding the second section of the associated limb.

20. The circular saw as claimed in claim 13, wherein the second portion of each said guide plate is an arcuate hook for holding the second section of the associated limb.
